(19) United States
(12) Patent Application Publication
(10) Pub. No.: US 2004/0238263 A1
(43) Pub. Date: Dec. 2, 2004

(54) Electric power steering apparatus

(76) Inventor: Takehiro Saruwatari, Osaka (JP)

Correspondence Address: BIRCH STEWART KOLASCH & BIRCH, PO BOX 747, FALLS CHURCH, VA, 22040-0747, US

(21) Appl. No.: 10/854,246

(22) Filed: May 27, 2004

(30) Foreign Application Priority Data
May 28, 2003 (JP) 2003-151298

(51) Int. Cl. B62D 5/04

(52) U.S. Cl. 180/444

(57) ABSTRACT

An electric power steering apparatus including: a steering rack shaft which has an external thread with a flat crest and can be moved in the axial direction in response to a steering operation; a ball screw mechanism, which has a nut screwed onto the external thread via balls so as to be relatively rotational, for transforming the rotational force of the electric motor into movement force in the axial direction and transmitting the movement force to the steering rack shaft; and a cylindrical member, which is fitted on the steering rack shaft, for depressing the deflection amount of the steering rack shaft, wherein the width of the flat crest of the external thread is 0.7 to 1.5 times as long as the diameter of the balls. The inner surface of the cylindrical member hardly abrades away even when the external thread contacts with the inner surface of the cylindrical member.

### CROSS-REFERENCE TO RELATED APPLICATIONS

This Nonprovisional application claims priority under 35 U.S.C. §119(a) on Patent Application No. 2003-151298 filed in Japan on May 28, 2003, the entire contents of which are hereby incorporated by reference.

### BACKGROUND OF THE INVENTION

The present invention relates to an electric power steering apparatus for assisting a steering operation of a vehicle by transmitting rotational force of an electric motor, which is used as a source of steering assist force, through a ball screw mechanism to a steering rack shaft in order to move the steering rack shaft to the right or the left of the vehicle.

An electric power steering apparatus for a vehicle comprises: a steering rack shaft which has a rack tooth and an external thread that are axially spaced, and can be moved in the axial direction in response to a steering operation; a nut which is screwed onto the external thread via a plurality of balls so as to be relatively rotational and joined on an output shaft of an electric motor; and a circulation member for circulating the balls between two end portions of the nut, wherein the nut is rotated in conjunction with rotation of the electric motor so that the steering rack shaft is moved in the axial direction with respect to the nut. The external thread of the steering rack shaft has a flat crest in order to heighten the rigidity of the thread.

The steering rack shaft of the electric power steering apparatus having such a structure is supported in a center-impeller way by a support member for supporting the rack tooth portion by elastically pressing the rack tooth portion toward a pinion, and the balls and nut. Accordingly, there arises deflection at the steering rack shaft having a relatively long support span due to reaction force from road surface and the like. One of electric power steering apparatuses constructed to depress the deflection amount of the steering rack shaft is an apparatus wherein a cylindrical member is fitted in the middle of the steering rack shaft so that the deflection amount of the steering rack shaft is depressed by contact between the inner surface of the cylindrical member and an outer portion of the steering rack shaft (disclosed, for example, in U.S. Pat. No. 5,927,429).

Regarding such an electric power steering apparatus provided with a cylindrical member for depressing the deflection amount of the steering rack shaft, however, when the cylindrical member is arranged within an area where the external thread of the steering rack shaft moves, the contact area between the external thread portion and the cylindrical member is smaller than the contact area between the steering rack shaft and the cylindrical member in a state where the cylindrical member is arranged outside the area where the external thread moves. This causes a relatively large contact pressure to be generated at the cylindrical member, making the inner surface of the cylindrical member more susceptible to abrasion by the contact pressure. The abrasion of the inner surface of the cylindrical member causes backlash to be generated between the external thread and the nut or between the rack tooth and the pinion, lowers maneuvability of the steering rack shaft, heightens the possibility of occurrence of rattling due to the backlash, and generates powder due to abrasion.

### BRIEF SUMMARY OF THE INVENTION

The present invention has been made with the aim of solving the above problems, and it is an object thereof to provide an electric power steering apparatus capable of lowering the possibility of occurrence of abrasion of the inner surface of the cylindrical member even when the cylindrical member is arranged within an area where the eternal thread moves.

An electric power steering apparatus according to the present invention comprises a steering rack shaft which has an external thread with a flat crest and can be moved in the axial direction in response to a steering operation; a ball screw mechanism, which has a nut screwed onto the external thread via a plurality of balls so as to be relatively rotational, for transforming the rotational force of an electric motor into movement force to move the steering rack shaft in the axial direction and transmitting the transformed movement force to the steering rack shaft; and a cylindrical member, which is fitted on the steering rack shaft, for depressing the deflection amount of the steering rack shaft, wherein the width of the flat crest of the external thread is 0.7 to 1.5 times as long as the diameter of the balls.

Since the width of the flat crest of the external thread is 0.7 to 1.5 times as long as the diameter of the balls, the external thread portion of the steering rack shaft comes into contact with the inner surface of the cylindrical member, so that the contact pressure generated when the cylindrical member depresses the deflection amount of the steering rack shaft is reduced and the possibility of occurrence of abrasion of the inner surface of the cylindrical member can be lowered. It is thus possible to reduce backlash, rattling and abrasion powder due to the abrasion of the cylindrical member.

It should be noted that a width of the flat crest less than 0.7 times as long as the diameter of the balls is not preferable since the contact pressure generated at the cylindrical member heightens possibility of occurrence of abrasion of the inner surface of the cylindrical member and the life of the cylindrical member is shortened. On the other hand, a width of the flat crest more than 1.5 times as long as the diameter of the balls is not preferable since the lead of the external thread becomes too long and a sufficient amount of transformed force (axial force) cannot be obtained.

The above and further objects and features of the invention will more fully be apparent from the following detailed description with accompanying drawings.

### BRIEF DESCRIPTION OF THE SEVERAL VIEWS OF THE DRAWINGS

FIG. 1 is a schematic view showing the whole structure of the electric power steering apparatus according to the present invention;

FIG. 2 is an enlarged sectional view showing an essential part of the electric power steering apparatus according to the present invention;

FIG. 3 is a sectional view magnifying an external thread portion of a steering rack shaft of the electric power steering apparatus according to the present invention; and

FIG. 4 is a graph showing a ratio necessary for making a cylindrical member longer than the width of a flat crest of the external thread.

### DETAILED DESCRIPTION OF THE INVENTION

The following description will explain the present invention in detail with reference to the drawings illustrating an embodiment thereof.

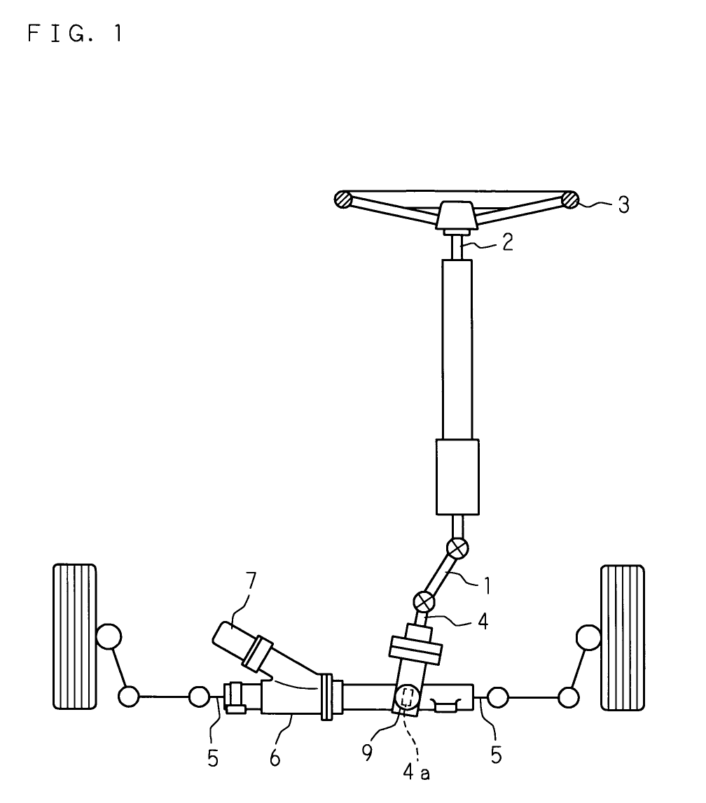

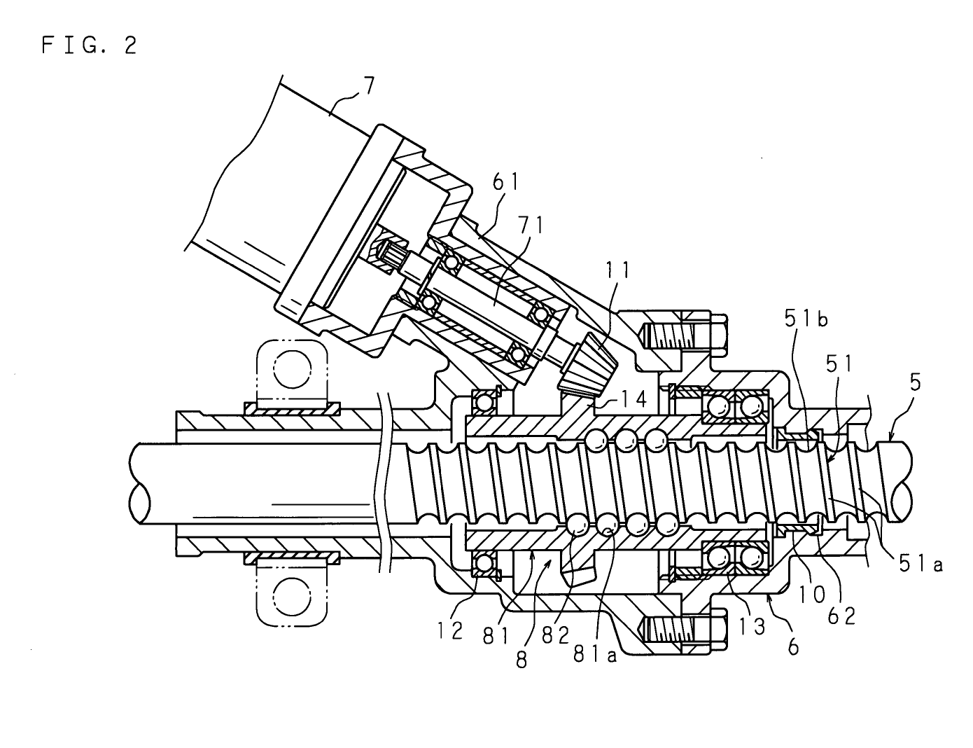

FIG. 1 is a schematic view showing the whole structure of an electric power steering apparatus according to the present invention, and FIG. 2 is an enlarged sectional view showing an essential part thereof

The electric power steering apparatus shown in FIG. 1 comprises: a transmission shaft 4 which has an end portion joined on a steering wheel 3 via a universal joint 1 and a steering shaft 2, and the other end portion provided with a pinion 4a; a steering rack shaft 5 which has a rack tooth (not shown) to be engaged with the pinion 4a and an external thread 51 that is axially spaced from the rack tooth and can be moved in the axial direction; a substantially cylindrical housing 6 for housing and supporting the steering rack shaft 5 so as to be freely movable; an electric motor 7 arranged outside the housing 6 with an output shaft 71 intersecting with the center axis of the steering rack shaft 5; and a ball screw mechanism 8, which has a nut 81 arranged in the housing 6 coaxially with the steering rack shaft 5, for transforming the rotational force of the electric motor 7 into the movement force in the axial direction and transmitting the transformed movement force to the steering rack shaft 5.

The steering rack shaft 5 is supported in a center-impeller way by a support member 9 for supporting the rack tooth portion by elastically pressing the rack tooth portion toward the pinion 4a and by the ball screw mechanism 8. The rack tooth and the external thread 51 are formed to have a length which ensures the movement amount of the steering rack shaft 5 that moves when the steering wheel 3 is steered to the left or the right from the steering neutral position. The external thread 51 has a semicircular groove portion 51b and a flat crest 51a.

Provided inside the housing 6 are the nut 81, and a cylindrical member 10, which is fitted on the steering rack shaft 5 between two support portions composed of the support member 9 and the ball screw mechanism 8, for depressing the deflection amount of the steering rack shaft 5. Provided in the longitudinal middle of the housing 6 is a motor attachment portion 61 configured as an opening which reaches the outside, and the electric motor 7 is attached to the motor attachment portion 61. Provided at the output shaft 71 of this electric motor 7 is a pinion 11 configured as a bevel gear.

Two end portions of the nut 81 are supported via bearings 12 and 13 so as to be freely rotatable, so that the movement of the nut 81 in the axial direction is restricted. Provided at the inner portion of this nut 81 is an internal thread 81a corresponding to the external thread 51, and a plurality of balls 82 are interposed between the internal thread 81a and the external thread 51. A gear wheel 14 configured as a bevel gear to be engaged with the pinion 11 is provided integrally at the outer portion of the nut 81. The ball screw mechanism 8 is provided with the external thread 51, the nut 81 having the internal thread 81a, the balls 82, and a circulation member (not shown) for circulating the balls 82 between the two end portions of the nut 81.

The cylindrical member 10 is arranged within an area where the external thread 51 moves, so that the cylindrical member 10 does not come into contact with the steering rack shaft 5 while the steering rack shaft 5 is not deflected but comes into contact with the external portion of the steering rack shaft 5 when deflection occurs at the steering rack shaft 5 and depresses the deflection amount of the steering rack shaft 5. The cylindrical member 10 has an inner diameter slightly larger than an outer diameter of the external thread 51 and is fixed in an annular recess 62 of the housing 6.

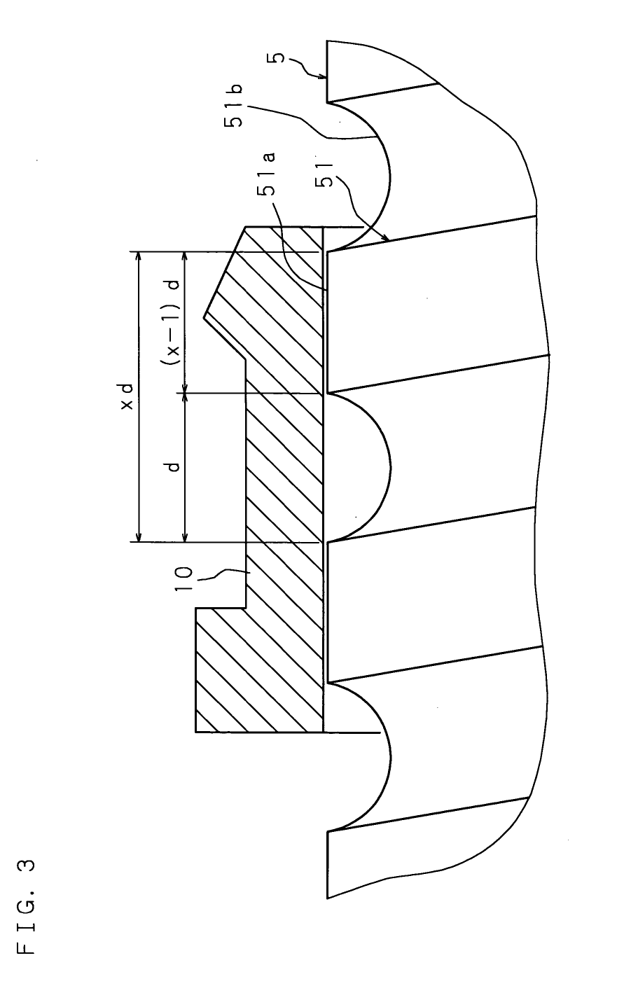

FIG. 3 is a sectional view magnifying the external thread 51 portion of the steering rack shaft 5. The external thread 51 of the steering rack shaft 5, the deflection amount of which is to be depressed by the cylindrical member 10 as described above, has the flat crest 51a with a width 0.7 to 1.5 times as long as the diameter of the balls 82. Since the contact area between the cylindrical member 10 and a portion of the steering rack shaft 5 where the external thread 51 is formed is smaller than the contact area between the cylindrical member 10 and a portion of the steering rack shaft 5 where the external thread 51 is not formed, it is necessary to form the cylindrical member 10 arranged within the area where the external thread 51 moves longer than a cylindrical member arranged outside the are where the external thread 51 moves.

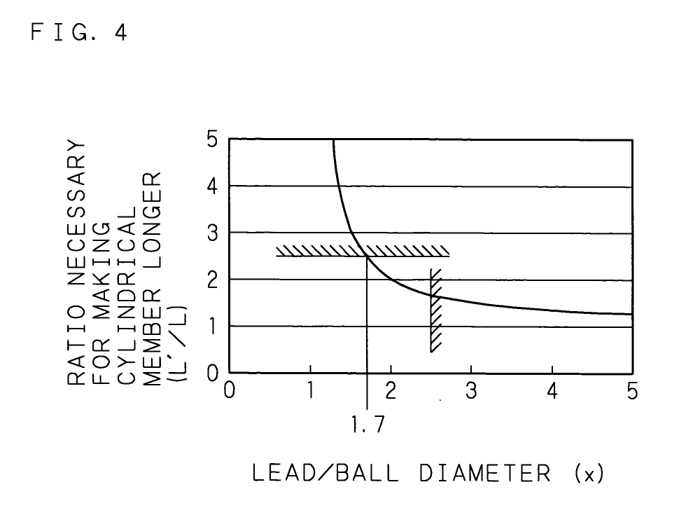

FIG. 4 is a graph showing a ratio necessary for making the cylindrical member 10 longer than the width of the flat crest 51a of the external thread 51. Assuming that “L” indicates the length of the cylindrical member 10 arranged outside the area where the external thread 51 moves and “L′” indicates the length of the cylindrical member 10 arranged within the area where the external thread 51 moves, the vertical axis of the graph shows a ratio L′/L and the horizontal axis shows a ratio x of the lead to the diameter of the balls 82. That is, assuming that “d” indicates the diameter of the balls 82, the lead is indicated by “xd”, and the ratio L′/L necessary for making the cylindrical member 10 longer than the width of the flat crest 51a can be found as a function of “x” with the following formula (1) (see FIG. 3). FIG. 4 shows this function. It should be noted that the ratio of the width of the flat crest 51a to the diameter of the balls 82 is found by subtracting “1” from “x”.

$${L}^{′} = L \times \frac{x d}{( x - 1 ) d} \\ ∴ \frac{{L}^{′}}{L} = \frac{x}{x - 1} \qquad ( 1 )$$

As shown in FIG. 4, when “x” is less than 1.7, i.e. when the width of the flat crest 51a is less than 0.7 times as long as the diameter of the balls 82, the necessary ratio L′/L exceeds 2.5 and increases at a great rate. It is not preferable that the ratio L′/L exceeds 2.5 as above, since the overall length of the housing 6 for holding the cylindrical member 10 becomes long, and the whole equipment of the electric power steering apparatus grows in size and serves as layout impediments when installed on a vehicle body. It is also not preferable that “x” exceeds 2.5, i.e. that the width of the flat crest 51a is more than 1.5 times as long as the diameter of the balls 82, since, though the ratio L′/L is low, the lead of the external thread 51 increases as “x” increases and a sufficient amount of transformed force (axial force) cannot be obtained.

With the electric power steering apparatus having such a structure, the steering force of the steering wheel 3 is transmitted through the pinion 4a of the transmission shaft 4 to the rack tooth of the steering rack shaft 5 and the electric motor 7 is driven in a controlled manner according to the steering torque generated by a steering operation of the steering wheel 3. With the drive of the electric motor 7, the rotational force of the output shaft 71 generated by the electric motor 7 is transmitted through the pinion 11 and the gear wheel 14 to the nut 81, the nut 81 is rotated, the rotational torque of the nut 81 is transmitted through the balls 82 to the external thread 51, and the steering rack shaft 5 is moved in the axial direction by a component of the force transmitted, so that a force to be applied to the steering wheel 3 for a steering operation can be reduced. When there arises deflection at the steering rack shaft 5 due to reaction force from road surface and the like, the outer portion of the steering rack shaft 5 including a portion configured as the external thread 51 comes into contact with the inner surface of the cylindrical member 10, so that the deflection amount of the steering rack shaft 5 can be depressed.

It should be noted that an electric power steering apparatus according to the present invention may have, instead of the structure wherein the electric motor 7 is arranged so as to intersect with the center axis of the steering rack shaft 5, a structure wherein the electric motor 7 is arranged coaxially with the steering rack shaft 5. Moreover, though the cylindrical member 10 explained in the above embodiment is arranged at a portion of the steering rack shaft 5 between the two support portions composed of the support member 9 and the ball screw mechanism 8, the cylindrical member 10 may alternatively be arranged outside the region extending between the two support portions.

With this invention, as described above, the contact pressure generated when the cylindrical member depresses the deflection amount of the steering rack shaft is reduced and the possibility of occurrence of abrasion of the inner surface of the cylindrical member can be lowered.

As this invention may be embodied in several forms without departing from the spirit of essential characteristics thereof, the present embodiment is therefore illustrative and not restrictive, since the scope of the invention is defined by the appended claims rather than by the description preceding them, and all changes that fall within metes and bounds of the claims, or equivalence of such metes and bounds thereof are therefore intended to be embraced by the claims.

1. An electric power steering apparatus comprising:
a steering rack shaft which has an external thread with a flat crest and is moved in an axial direction in response to a steering operation;
a ball screw mechanism, which has a nut screwed onto the external thread via a plurality of balls so as to be relatively rotational, for transforming rotational force of an electric motor into movement force in the axial direction and transmitting the transformed movement force to the steering rack shaft; and
a cylindrical member, which is fitted on the steering rack shaft, for depressing a deflection amount of the steering rack shaft,
wherein a width of the flat crest of the external thread is 0.7 to 1.5 times as long as a diameter of the balls.

2. The electric power steering apparatus according to claim 1, wherein
the external thread has a semicircular groove portion.

3. The electric power steering apparatus according to claim 1, wherein
the cylindrical member is arranged within an area where the external thread moves.

4. The electric power steering apparatus according to claim 1, wherein
the steering rack shaft is supported in a center-impeller way by a support member for supporting a portion to be engaged with a pinion and the ball screw mechanism.

5. The electric power steering apparatus according to claim 4, wherein
the cylindrical member is fitted on the steering rack shaft between the support member and the ball screw mechanism.

6. The electric power steering apparatus according to claim 1, wherein
an internal thread corresponding to the external thread is provided at an inner portion of the nut and the balls are interposed between the internal thread and the external thread.
